(19) United States
(12) Patent Application Publication
(10) Pub. No.: US 2005/0270647 A1
(43) Pub. Date: Dec. 8, 2005

(54) Two-dimensional diffraction grating with alternate multilayered stacks and its process of manufacture, and spectroscopic devices including these gratings

(76) Inventors: Francois Polack, Paris (FR); Mourad Idir, Palaiseau (FR); Erick Jourdain, Bagnolet (FR); Audrey Liard-Cloup, Bourg-La-Reine (FR)

Correspondence Address: ANTHONY H. HANDAL;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 11/021,974

(22) Filed: Dec. 23, 2004

(30) Foreign Application Priority Data
Dec. 23, 2003 (FR) 03 51192

(51) Int. Cl. G02B 5/18

(52) U.S. Cl. 359/567

(57) ABSTRACT

The invention concerns a two-dimensional diffraction gratting for the dispersion of polychromatic or quasi-monochromatic luminous flux including a substrate (2) having a surface (3), a first (5) and a second (6) stacks of thin biperiodic layers of period d in the thickness direction, including at least ten periods, each period d being formed of layers of at least two different materials (7, 8), said stacks (5, 6) forming contiguous lines (11) of width p/2, parallel to one another, and repeated periodically along a direction parallel to the surface of the substrate (2) with a period p, the second stack (6) being alternate with the first stack (5) and offset in width by d/2, so that the stacks (5 and 6) form a thick gratting (9) carried by the substrate (2).

According to the invention, said thick grafting (9) consists of the doubly periodical repetition of a same unit cell, topped with a thin surface gratting (10) having an amplitude at the most equal to d/2.

The present invention concerns a two-dimensional diffraction gratting for the dispersion of polychromatic or quasi-monochromatic luminous flux, its process of manufacture, as well as monochromators and spectrometers including these grattings.

By two-dimensional gratting is meant a gratting which extends simultaneously along the direction of the surface of the substrate and along the direction perpendicular to this surface.

The gratings by reflection are used conventionally in infrared, visible, ultraviolet light and up to the domain of X-rays when the photon energies do not exceed 2000 eV. Manufactured in diverse materials (Silicium, quartz, . . . ), the grattings for the shorter wavelengths have generally a lamellar profile, i.e. a profile approaching at best a rectangular strobe. This profile may be obtained by chemical attack or by ionic bombarding of a surface perfectly polished through a photolithographic mask. It is this mode of manufacture which provides the best regularity of profile as well as the best rigidity of the engraving flanks and, consequently, the best performances in terms of diffracted light relative to the spurious light diffused. The lamellar grattings have the shortcoming of diffracting the light in numerous orders (positive or negative). Judicious choice of the cyclic ratio, hollow/period, enables however to reduce the intensity of the even orders. The maximum efficiency in a given order is obtained when the radiation diffracted by the upper portion of the strobe and that diffracted by its lower portion are in phase, i.e.

$$h ( cos {α}_{i} + cos {α}_{d} ) = \{ \begin{matrix}λ / 2 & for odd orders \\ λ & for even orders\end{matrix}$$

where the incidence angle αᵢ and the diffraction angle α_{d} are marked relative to the plane of the surface of the diffraction grafting. These can be considered as glancing incident angles or glancing angles. The surface of the gratting is then covered with a thin layer of high density material, for example Platinum or Gold. By reason of the very small deviation relative to 1 of the optical indices of the materials in the domain of X-rays, these coating layers only exhibit the required reflectivity properties only for a very glancing incidence of the radiation, the weaker so that the energy of photons is high.

Still, in a monochromator or a spectrometer, the wavelength is selected by the incidence angle of the light on the grafting. Being restricted to glancing incidence angles reduces the wavelength range wherein a same grafting may be used. Moreover, “shadowing” effects reduce significantly the diffraction efficiency. These “shadowing” effects result from the fact that certain portions of the surface of the grafting, either cannot receive directly the incident radiation, or may not radiate directly along the direction of the useful order.

It is also usual practice to vary gradually the parameters of these grattings relative to the position on the surface, most often the period (HETTRICK M. and al.; Appl. Opt. 23 (1983) 3921, HETTRICK M.; Appl. Opt 22 (1984) 3221) but also the depth of the lines (FRANKS A., U.S. Pat. No. 3,980,883) on the surface of the substrate.

It is known to use grattings at small blaze angle scale to improve the diffraction efficiency of a gratting. The radiation is reflected by each facet of the gratting, along a privileged direction thereby reinforcing the diffraction efficiency in a particular order. It is the “blaze” angle. However, the reflectivity limits the deviation to the same angular range as that of the lamellar grattings. The blaze angle remains however small. For photon energies of the order of the keV, the angle of the facets is close to 1°, which renders very difficult the fabrication of such blazed grattings.

One also knows engraved grattings coated with a multilayered stack. These grattings consist of an engraven gratting in a substrate as described previously, whereon is deposited a reflective treatment formed of a stack of thin layers. This stack consists of thin layers of a dense element (high index) and of another lighter element (low index) alternately deposited on the substrate. The operating principle of such a reflecting coating layer, substantially identical to that of the multi-dielectric stacks for the visible range, is based on the penetration of the radiation inside a very large number of layers and the cooperating behaviour of each of the interfaces when the following phasing condition is satisfactory:
e sin α=kλ/4
where e is the thickness of the layer, α the glancing incidence angle on the interface of a radiation and λ the wavelength of the radiation.

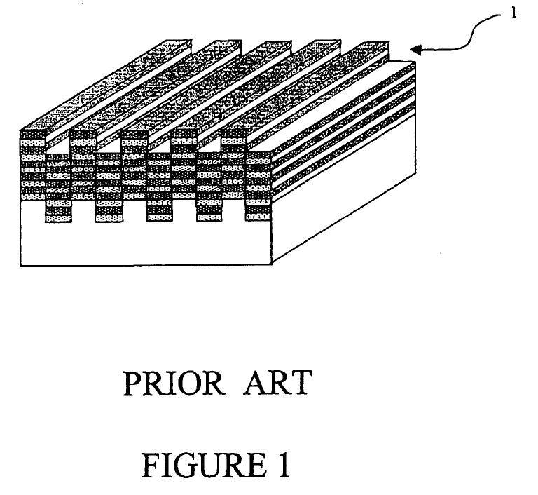

The patent U.S. Pat. No. 4,915,463 (BARBEE, T. W., Jr.) (FIG. 1) describes a diffraction grafting by reflection comprising a lamellar gratting of period d and a set of synthetic multilayers of period d which is a stack of alternate layers of two different materials. The relation which the period, d, of the stack and the engraving depth, H, of the steps of the gratting must satisfy for this type of gratting is specified equal to:

$$H / d = k \text{/} {m ( 1 - \frac{2 δ}{{sin}^{2} A} )}^{1 / 2} \qquad ( 1 )$$

where δ is the deviation relative to 1 of the average index of the stack, A the glancing incidence angle, k being a random integer and m the order of Bragg wherein the multilayered gratting is used.

However, it is here implicitly considered that the ratio H/d is high. The corrective term of this formula (1) is derived from the fact that the radiation propagating in the multilayer of average index 1−δ and that which propagates in vacuum, are not in phase at a given depth. The considerations which lead to the formula (1) specify, moreover, simplifications which are valid only for a little dispersive gratting used under an incidence quite close to the normal.

Heinzmann U (J. of Physique III; vol. 4, no. 9, p: 1625-1637; 01109/1994) puts in evidence that the relation between the engraving depth and the period of the multilayer controls the efficiency in the different orders of diffraction. It states that the order 0 is cancelled if the engraving depth is equal to an odd number impair of times the semi-period of the stack.

In the example studied by Heinzmann, the engraving depth is equal to 5 times the semi-period of the multilayer. There results the presence of a surface gratting whereof the modulation depth is significant, 5d/2 for 19d/2 of thickness of biperiodic gratting. This gratting which alternates vacuum and multilayer, is not optimised and generates a coupling between the useful order and the undesirable orders. The performance of the gratting is consequently affected and the cancellation of the order 0 remains incomplete. Moreover, the use in normal incidence induces substantially identical efficiency in orders +1 and −1.

The application of a multilayered coating on an engraven gratting has also been extended to blazed grattings, with notably the hope to reinforce the blaze effect to very high orders to benefit from very high dispersions {RIFE J. C. and al.; Physica Scripta 41 (1990) 418}.

One also knows grattings formed by deep engraving of a multilayered stack. Further to a first article of Erko {ERKO A. I. and al.; Nucl. Instrum. Meth. A 333 (1993) 599} a vast number of publications has been dedicated to the methods of fabrication and to the properties of this type of grattings. One will note in particular among these publications, a study of amorphous multilayered grattings W/Si having a lateral periodicity of 800 nm based on a three-dimensional representation in the reciprocal space of said grattings by Mikulik {Mikulik P. and al.; J. Phys. D: Appl. Phys. 34 (2001) A188}. If the engraving is deep and if the leading flanks of the engraven profiles are vertical, one realises a biperiodic structure, usually called lamellar multilayered gratting.

These grattings are biperiodic but are not continuous and exhibits gaps inside their structure. There results that the sudden transition between the materials of the multilayer and the vacuum tends to send light in all the orders of diffraction, as it is the case with conventional lamellar grattings with metal coating. Thus, if these multilayered grattings improve the diffraction efficiency of the grattings, they do not enable selection of certain orders of diffraction.

The object of the present invention is to provide a diffraction gratting, simple in its design and economical, behaving like a synthetic crystal and enabling to obtain symmetries in the unit cell in order to reduce or eliminate the diffracted light in certain orders while reinforcing the diffraction efficiency of the orders authorised.

To this end, the invention concerns two-dimensional diffraction gratting for the dispersion of polychromatic or quasi-monochromatic luminous flux including:
a substrate having a surface,
a first and a second stacks of thin biperiodic layers of period d in the thickness direction, including at least ten periods, each period d being formed of layers of at least two different materials, said stacks forming contiguous lines of width p/2, parallel to one another, and repeated periodically along a direction parallel to the surface of the substrate with a period p, the second stack being alternate with the first stack and offset in width by d/2, so that the stacks form a thick gratting carried by the substrate.

According to the invention, said thick grafting consists of the doubly periodical repetition of a same unit cell, topped with a thin surface gratting having an amplitude at the most equal to d/2.

In different embodiments, the present invention also concerns the following characteristics which should be considered individually or according to all their technically possible combinations:
the external surface of the two-dimensional grafting does not include any thin surface gratting,
the substrate whereon lies the thick gratting possesses an embossed surface including lines parallel to one another, of periodicity p and being in phase with one of the stacks,
the substrate has an embossed surface exhibiting a triangular profile, of a base width p/2, of a depth d/2 at the most and of periodicity p/2 in phase with the stacks, the substrate has a planar upper surface,
the substrate has a concave, convex, spherical or aspherical upper surface,
the period p of the of the gratting varies continuously according to the position at the surface of the substrate the period d of the thin layers varies continuously according to the position at the surface of the substrate
the two-dimensional diffraction grafting comprises a protection layer deposited on said first and second stacks of layers,
the two-dimensional diffraction grafting comprises a hooking layer between the substrate and the first layer of each stack,
the two-dimensional diffraction gratting comprises a barrier layer between successive materials,
the distribution of the indices of the materials forming an unit cell shows symmetries or antisymmetries so that when in use at least one order of diffraction is weakened or strengthened,
the distribution of the indices of the materials forming the unit cell shows a symmetry relative to the centre of said unit cell,
the unit cell is formed of two materials having different optical indices,
the period p of the gratting and the period d of the vary continuously according to the position at the surface of the grating so that the ratio d/p remains constant at all points.

The invention also concerns a process for the preparation of a two-dimensional diffraction gratting.

In different embodiments, the present invention also concerns the following characteristics which should be considered individually or according to all their technically possible combinations:
an embossed surface including periodical embossed or hollow patterns, of height or depth d/2 is performed on a substrate,
a stack of thin periodical layers of period d is deposited, each period d consisting of layers of at least two different materials, so that a first and a second stacks are formed, having the same configuration, alternate, contiguous and dephased by d/2 along the direction of periodicity d perpendicular to the surface of the substrate,
periodical hollow patterns are formed by an in situ engraving process,
periodical embossed patterns are formed by an in situ deposition process,
the process for the preparation of a two-dimensional gratting comprises a means to smoothen the embossed surface.

The invention finally concerns a spectroscopic device for analysing or filtering a luminous source including at least one diffraction gratting.

According to the invention, said gratting is a diffraction gratting as described previously.

In different embodiments, the present invention also concerns the following characteristics which should be considered individually or according to all their technically possible combinations:
the device is intended to receive a luminous beam including at least one radiation centred on a wavelength λ₀ emitted by a luminous source, the diffracted radiation of wavelength λ₀ by said gratting forming a deviation angle D with the incident beam.

According to the invention,
the two-dimensional diffraction grafting is oriented so that the normal to the gratting forms an angle B constant within +10% with the bisectrix at the deviation angle D,
the angle D and the wavelength λ₀ of said radiation verifying the following equation:

$$2 sin ( \frac{D}{2} ) \times sin B = q \frac{{λ}_{0}}{p}$$

where p is the period of the gratting in the plane of its surface, q is the order of diffraction along this direction,
the angle B is defined by the relation

$$tan B = \frac{q d}{r p} ( 1 - \frac{( 1 - \overline{n} )}{{( \frac{r {λ}_{0}}{2 d} )}^{2} - {( \frac{q d}{r p} )}^{2}} )$$

where d is the period of the grafting according to the axis perpendicular to the surface of the grafting and r the order of diffraction along this direction and \overline{n} the average index of the gratting,
the spectroscopic device comprises a dispersive device including said two-dimensional diffraction grafting and a mirror placed before or after said gratting,
said mirror including a multilayered structure comprising the same materials and having the same periodicity along a direction normal to the surface as said first and second stacks of layers of the diffraction gratting,
said mirror being oriented in order to receive the luminous beam diffracted under an incidence angle D/2 relative to its surface so that the beam diffracted by the gratting and transmitted by the whole device remains parallel to the incident beam.

In different possible embodiments, the invention will be described more in detail with reference to the appended drawings wherein:

FIG. 1 is a schematic representation of a multilayered gratting of the previous art;

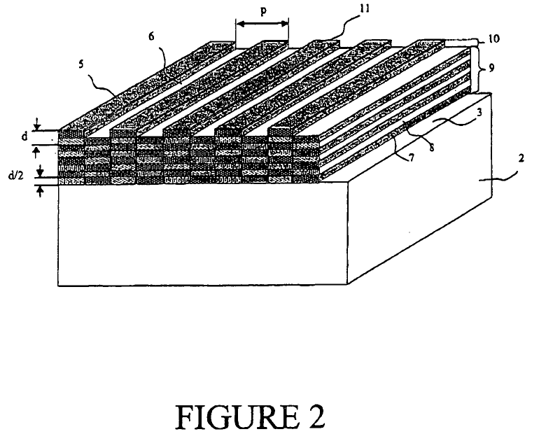

FIG. 2 is a schematic representation of a diffraction gratting according to a first embodiment of the invention;

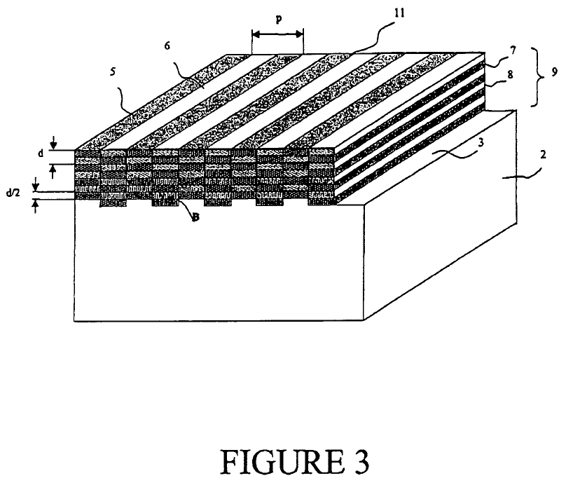

FIG. 3 is a schematic representation of a diffraction grafting according to a second embodiment of the invention;

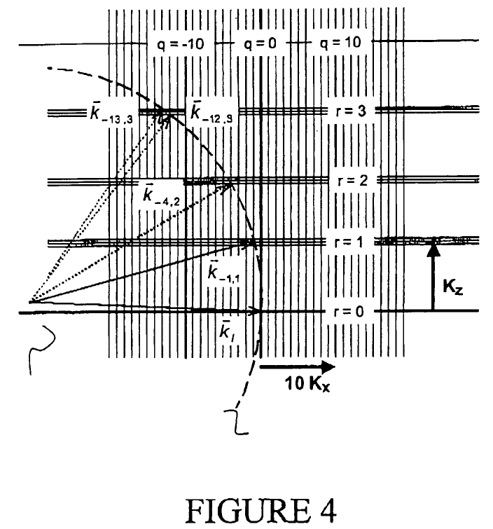

FIG. 4 shows the Ewald construction enabling to determine for a glancing incidence defined by the wave vector \vec{k}₁ and at a wavelength λ, the diffracted orders characterised by the wave vectors \overline{k}₋₁₃₁, \overline{k}_{-4.2}, \vec{k}_{-12,3}, \vec{k}_{-13,3};

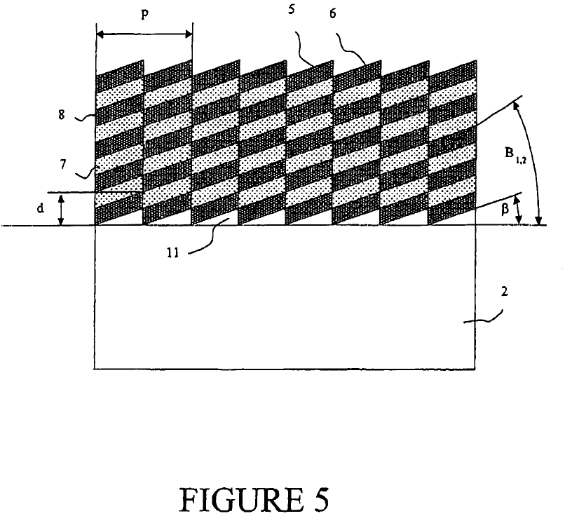

FIG. 5 is a schematic representation of a diffraction gratting according to a third embodiment of the invention;

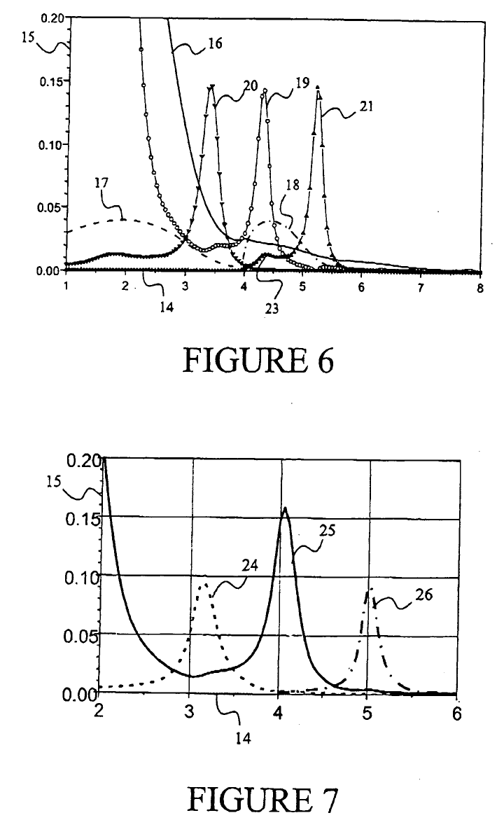

FIG. 6 is a schematic representation of a digital simulation of the diffraction efficiency of a grafting relative to the glancing incidence in the orders −1, 0, +1 for a realisation of the diffraction grafting of FIG. 2 at a wavelength of 1 nm, and compared to that of a conventional metal gratting;

FIG. 7 is a schematic representation of measurements of the diffraction efficiency of a gratting relative to the glancing incidence in the orders −1, 0, +1 for the realisation of the diffraction gratting of FIG. 2 corresponding to the digital simulation represented on FIG. 6;

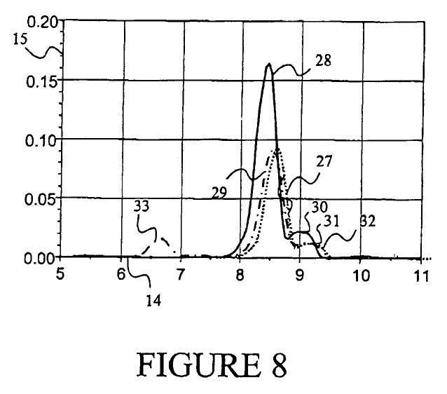

FIG. 8 is a schematic representation of measurements of the diffraction efficiency of this grafting relative to the deviation angle D for three fixed incidences of the radiation in the orders −1, 0, +1 for the diffraction gratting of FIG. 2, and at a wavelength of 1 nm;

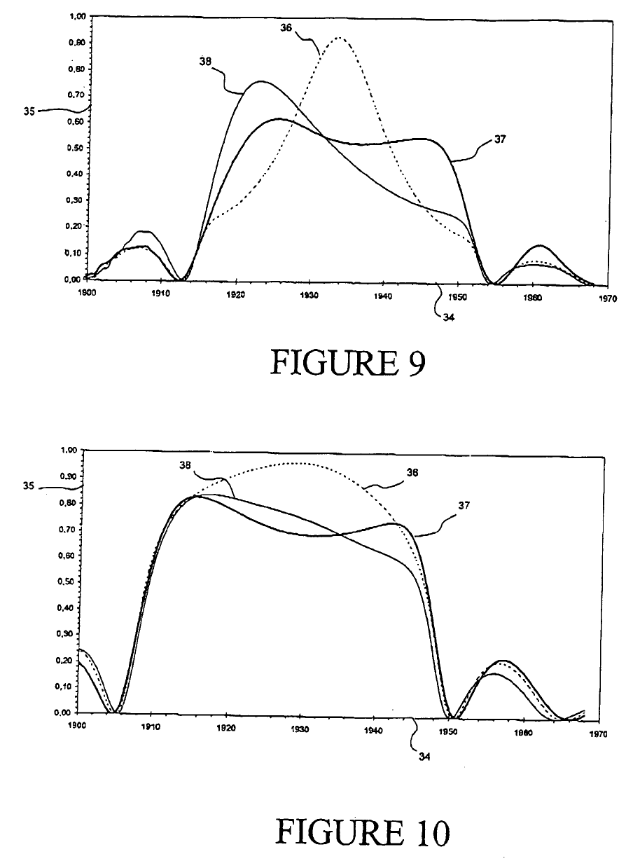

FIGS. 9 to 24 represent different examples of diffraction grattings according to the invention;

The diffraction grafting of the invention comprises in a first embodiment, represented on FIG. 2, a first 5 and a second 6 stacks of thin biperiodic layers of period d in the thickness direction, including at least ten periods (not represented), each period d being formed of layers of at least two different materials 7, 8. The stacks 5, 6 form contiguous lines 11 of width p/2, parallel to one another and repeated periodically along a direction parallel to the surface 3 of the substrate 2 with a period p. The second stack 6 is alternate with the first stack 5 and offset in width by d/2, so that the stacks 5 and 6 form a thick gratting 9 carried by the substrate 2.

According to the invention, the thick grafting 9 consists of the doubly periodical repetition of a same unit cell, topped with a thin surface grafting 10 having an amplitude at the most equal to d/2.

The diffraction grafting of the invention is intended for implementation with quasi-monochromatic or polychromatic incident beams.

The thin surface grafting 10 comprises lines including the first material 7, of thickness at the most of d/2, periodic of period p and separate by vacuums of thickness at the most of d/2.

The energy diffracted by a thin surface gratting 10 is relatively small, so that the properties that we shall now list, are little affected.

The first and second materials 7, 8 occupy advantageously identical volumes (FIG. 2), i.e. the height of the layer of the first material 7 is equal to the height of the layer of the second material 8 is d/2, and the embossed depth of the thin surface gratting 10 is advantageously as small as possible.

The substrate 2 whereon lies the thick gratting 9 may contain an embossed surface including lines 11 parallel to one another, of periodicity p and being in phase with one of the stacks (FIG. 3). The substrate 2 may be composed of different materials from those of the thick grafting 9 or of the same materials.

The substrate 2 may have an upper planar, concave, convex, spherical or aspherical surface 3.

The thick gratting 9 may contain two or several different materials (m₁, m₂, m₃). It may also comprise barrier layers preventing interdiffusion of the materials between the layers. It may also comprise hooking layers. The thick grafting 9 as well as the thin surface gratting 10 may comprise a protection layer deposited on the surface 3.

FIG. 3 shows a diffraction grafting in a second embodiment. This diffraction gratting comprises a substrate 2 and a thick grafting 9 formed of a first 5 and of a second 6 stacks of thin layers. To manufacture this diffraction gratting, one deposits first of all on a substrate 2 of an appropriate material, a resin of constant thickness. Two coherent luminous waves are made to interfere on this layer, waves issued from two distinct space points, possibly situated at infinity and generated initially from a laser, under such conditions that the resin layer intercepts the interference volume of both waves, the luminous energy shows, in this volume causing polymerisation or de-polymerisation, resin at constructive interference locations.

A solvent is then caused to act to solve selectively either the resin which has been polymerised or the resin which has not been polymerised, to show the lines forming the surface embossed patterns of the substrate 2. This constitutes an in-situ engraving method.

Advantageously, the modulation depth will generally have to be amplified by a selective engraving method (chemical, ionic, reactive engraving, or other) analogous to those used in microelectronics.

The substrate 2 thus prepared shows at its surface 3 embossed parallel lines 11 having a rectangular lamellar profile, possibly trapezoidal with a small-flanked width, of period p, of depth h=d/2 and of cyclic ratio 1/2, i.e. it shows the same width high and low faces of the profile. The ratio dip is selected to obtain a blaze angle of some degrees according to the relation (7).

On this substrate 2, one deposits, by an in-situ deposition method, alternately the thin layers of a first 7 and of a second 8 materials (respectively m₁, m₂) selected to present between themselves high index variation in the spectral domain of interest. The diffraction gratting of the invention thus formed comprises a thick gratting 9 including a first stack 5 of thin layers, periodic of period d, including at least ten periods, forming lines of width p/2 parallel to one another, separate, spaced periodically with a period p and a second stack 6 of thin periodic layers of period d of arrangement identical to the first stack 5, forming lines 11 of width p/2 parallel to one another, separate, spaced periodically with a same period p, said second stack 6 being interlaced with the first stack 5, contiguous with the first stack 5 and dephased according to the direction perpendicular to the substrate 2 of the engraving depth h=d/2. The layers of each of both materials 7, 8 have the same thickness, the latter being equal to the engraving depth h=d/2 of the underlying substrate 2. The distribution of both materials 7, 8 shows therefore a symmetry relative to the centre of the unit cell.

There results from the construction specified above that the diffraction gratting shows initially at its surface a thin surface gratting 10, formed by the difference in height between the first stack 5 and the second stack 6 of thin layers.

Advantageously, the diffraction gratting does not include any thin surface gratting 10 as represented on FIG. 3. To do so, means are implemented to polish this surface as for example ionic machining.

The rapid attenuation of the incident wave inside the thick grafting 9, comprising said first and second stacks 5, 6 causes the deep layers not to affected, or little affected, by the radiation.

In a particular embodiment, the pitch p of the gratting as well as the period d of the thin layers are variable but the ratio d/p remains however the same at all points. The values of d and p may thus typically vary by 15% on 100 mm.

A theoretical approach has been developed to explain the possibility of reinforcing considerably the diffraction efficiency of this diffraction gratting for a small number of authorised diffracted waves, possibly a single one. According to this theory, a thick gratting 9 of this type which shows a double periodicity in two different directions, perpendicular and parallel to the surface 3 of the substrate 2, behaves like a synthetic crystal. If an incident wave of wave vector \vec{k}ᵢ; propagates in said doubly periodic structure 4, it may be coupled and therefore give rise to diffracted vector waves of wave \overline{k}_{d} only if the difference \overline{K} between both vector waves, called diffusion vector, is a vector of the reciprocal gratting of the biperiodic structure of the diffraction gratting considered (Bragg condition),
\overline{K}=q\overline{K}ₓ+r\overline{K}_{z}, (2)
where Kₓ and \overline{K}_{z}, of modules Kₓ=2π/p, K_{z}=2π/d, are the fundamental vectors of the reciprocal gratting of the thick gratting 9, and q and r are two integers called orders of diffraction along the direction considered. Let us note that both waves propagate in a same medium of average index

$$\overline{n} = \frac{{n}_{1} + {n}_{2}}{2}$$

with n₁ the index of the first material 7 and n₂ that of the second material 8, and consequently:
|k_{d}|=|kₗ|(3)

Thus, contrary to a conventional diffraction gratting, any incident wave does not give rise necessarily to diffracted beams. However, the Bragg condition is not as strict as for a perfect crystal, since the vertical penetration of the radiation is limited by absorption to several tens of pairs of layers. There results uncertainty on the values of K_{z} which provide a coupling with a diffracted wave ΔK_{z}/K_{z}=1/N, where N is the number of periods of the first and second stacks 5, 6 of thin layers which are involved in the formation of the diffracted wave. Along the horizontal direction, it is possible to illuminate a large grafting surface and the uncertainty on Kₓ is very small.

Another interesting analogy with the optics of the crystals is that the structure of the unit cell contributes to authorise or to prohibit particular orders of diffraction. The efficiency of the coupling between the incident wave, of wave vector \overline{k}ₗ and the diffracted wave \vec{k}_{d}, of wave vector \vec{k}_{d}=\overline{k}_{q,r}=\vec{k}ₗ+\overline{k}_{q,r} is proportional to the value pour \overline{K}=\vec{K}_{q,r} of the Fourier transform of the distribution of the variations of the optic index in the unit cell. For example, in the case where the unit cell is composed of two materials m₁ and m₂ 7, 8, this distribution of index is expressed by

$$\frac{{n}_{1} - {n}_{2}}{2} M ( x , z ) ,$$

where M(x,z) is a function which is equal to +1 in the first material 7 and −1 in the second material 8 of the stacks 5, 6. The factor of structure F(q,r) which describes the relative intensity between the different orders, is therefore proportional to |TF[M]|² where TF[M] is the Fourier transform of the function M (x,z). If the first and second materials 7, 8 are distributed relatively equally and regularly in the cell, the structure factor decreases rapidly with the indices. In the particular case of a gratting of cyclic ratio 1/2 in both directions, i.e. equal and symmetrical distribution of two materials 7, 8 around the centre of the unit cell, it is easy to show that the structure factor is nil for all the diffusions of even order in x as in z and that it is reduced, within one factor, to:

$$\{ \begin{matrix}F ( 2 q , r ) = 0 \\ F ( q , 2 r ) = 0 \\ F ( 2 q + 1 , 2 r + 1 ) = \frac{1}{{( 2 q + 1 )}^{2} {( 2 r + 1 )}^{2}}\end{matrix} \qquad ( 4 )$$

Generally speaking, any symmetry or antisymmetry in the distribution of the indices of the different materials 7, 8 forming the unit cell leads to cancelling or reducing the structure factor to certain nodes of the reciprocal grafting.

Finally, if the second condition is taken into account, equation (3) |k_{d}|=|kᵢ|, the incident wave is capable of being coupled efficiently only to a very small number of diffracted waves, possibly a single one, and the diffraction efficiency in these privileged orders is considerably reinforced. This reinforcement is formally equivalent to a blaze effect.

We shall now describe the agreement conditions for a given order to be selected by the diffraction gratting in a particular embodiment. By convention the direction of propagation of the waves will be marked by the glancing angles, i.e. the angle α, formed by the wave vector \vec{k} with a plane parallel to the surface 3 of the substrate 2, αᵢ is the incidence angle and α_{d} the diffraction angle. The waves propagating upwards correspond to positive angles, those which propagate downwards at negative angles. The radiation incident has a wavelength λ in the medium of average index \overline{n}, and the incidence plane is normal to the lines of the gratting. Under these conditions, the diffraction angle of the order of indices q and r, and the incidence angle verify the following relations deduced from the equations (2) and (3).

$$\begin{matrix}sin {α}_{d} - sin {α}_{l} = r \frac{λ}{d} & ( 5 ) \\ cos {α}_{d} - cos {α}_{l} = q \frac{λ}{p} & ( 6 )\end{matrix}$$

These equations may be re-written to put in evidence the deviation angle D and the asymmetry angle B so that αᵢ=−D/2+B and α_{d}=D/2+B:

$$\{ \begin{matrix}2 sin D / 2 cos B = r \frac{λ}{d} \\ 2 sin D / 2 sin B = q \frac{λ}{p}\end{matrix} \qquad ( 7 )$$

To meet the agreement condition at any wavelength, the gratting with a constant asymmetry angle B should be used, so that:

$$B = Atan \frac{q d}{r p} \qquad ( 8 )$$

This relation expresses that the diffraction in the order of indices q and r may be interpreted in the language of the crystallography, as a Bragg reflection on the reticular plane of the same indices q and r (cf FIG. 3). It may also be understood, in the language of conventional optics, as a blaze condition.

One may then determine by an Ewald construction the wave vectors of the orders liable to be diffracted (FIG. 4). The ends of the wave vectors 9 \overline{k}ₗ and \vec{k}_{d}=\vec{k}_{q,r} belong to a same circle 10 of radius 2π/λ and are situated on the nodes of the reciprocal gratting of pitch 2π/p and 2π/d. These nodes are widened along the direction \overline{K}_{z} by reason of the small penetration of the radiation in the thickness of the stack 5, 6. The gratting behaves in a narrow band of wavelength as an ordinary planar gratting which disperses angularly the light. The diffracted intensity decreases rapidly around the central wavelength defined by the relations (5) and (6). The maximum intensity diffracted is obtained when the condition of blaze is respected, i.e. when the gratting is tilted by a constant angle B relative to the bisectrix of the incidence and emergence directions given by the relation (8). Advantageously, the asymmetry angle B is selectively small, i.e. smaller than 5 degrees. Assuming that the gratting is illuminated under an incidence given by a monochromatic beam of wavelength λ and that this beam meets the Bragg condition (7) of indices q and r, there may exist other beams diffracted at the same wavelength λ but in a direction different. A grafting designed for working under glancing incidence will have a small blaze angle, B, and consequently a very large difference between the periods d and p. There ensures that the other diffracted orders will have varying indices r as the sequence of the integers, but indices q varying approximately like r². Rapid decrease of the structure factor (defined above at the formula (4)) with the indices involves very small coupling of the incident wave with spurious orders. In practice, one will choose to work in the orders q=+1, r=1 or q=−1, r=1 and one will strive to obtain a cyclic ratio close to 1/2 in both directions. As orders corresponding to even indices q or r pairs cannot propagate, the greatest part of the energy diffracted at the wavelength λ, will be diffracted in the order selected with a very reinforced efficiency; the reminder will be absorbed in the gratting.

If now the gratting, oriented to diffract according to the order (q,r), is illuminated by a polychromatic beam, the equations (5) and (6) show that the harmonic wavelengths of the agreement wavelength, λ′=λ/k, will be diffracted in the same direction as the order (q,r) in orders of indices q′=k q, r′=k r. Taking into account the rapid decrease in the structure factor, one may expect high reduction of the contamination of the beam diffracted by the upper harmonics, which is one of the major shortcomings of the conventional one-dimensional grattings in the domain of the X-rays. In a particular embodiment where the diffraction gratting has a cyclic ratio 1/2, described above, and is used in the orders (1,1) or (−1,1), the first harmonic diffracted is the harmonic 3 and its theoretical diffraction efficiency, while neglecting the variations of optical index, is only 1/81 of that of the harmonic 1.

However, the directions of waves which we have used until now, are those of the waves which propagate inside the diffraction grafting of average index

$$\overline{n} = \frac{{n}_{1} + {n}_{2}}{2}$$

with n₁ the index of the first material 7 and n₂ that of the second material 8 and the wavelength λ used is that of a incident beam in this medium, i.e. λ=λ0/n where λ0 is the wavelength in the vacuum of the incident beam. For exemplification purposes, we shall give thereafter a simplified determination of the blaze angle B applicable to the domain of wavelength VUV and X-rays. In the domain of the radiation VUV and X, the optical index being quite close to but smaller than 1, it is current to note \overline{n}=1−\overline{δ}. The relation between the propagation angle of a wave in the vacuum α′ and its angle α in the medium of the gratting is then
cos α′=\overline{n} cos α [symbol] sin α=\sqrt{sin²α′−2δ} (9)

If the incidence angle of the wave in the vacuum is sufficiently far from the total reflection angle while remaining glancing, \sqrt{2δ}<<sin α′<<1, one may use the approximation sin α=sin α′−\overline{δ}/sin α′. One then obtains corrected expressions equivalent to the equations (7):

$$\{ \begin{matrix}2 sin {D}^{′} / 2 cos {B}^{′} ( 1 - \frac{\overline{δ}}{{sin}^{2} {D}^{′} / 2 - {sin}^{2} {B}^{′}} ) = r \frac{{λ}_{0}}{d} \\ 2 sin {D}^{′} / 2 sin {B}^{′} = q \frac{{λ}_{0}}{p}\end{matrix} \qquad ( 10 )$$

One will observe that the relation of diffraction by the lateral gratting remains unchanged. The only change is the blaze condition at which a correction is necessary, depending on the wavelength. By assuming D′ and B′ at their not corrected values, one obtains an approximate value of the blaze angle:

$$tan {B}^{′} = \frac{qd}{rp} ( 1 - \frac{\overline{δ}}{{( {rλ}_{0} / 2 d )}^{2} - {( qd / rp )}^{2}} ) \qquad ( 11 )$$

The fundamental properties of the gratting which have just been described are dues to
a double lateral and in-depth periodicity, and to a usage in X-rays under glancing incidence with small blaze angles, typically of the orders (1,1) or (−1,1), which will therefore limit the wavelengths which may be diffracted for a given incidence in a given order.
a distribution of the materials 7, 8 regularly alternate so that the cyclic ratios along directions parallel and perpendicular to the surface 3 of the substrate 2 are close to 1/2, which limits the number of orders effectively diffracted and reinforces the efficiency thereof.

The invention also relates to the use of a gratting with alternate multilayers in a spectroscopy device. Exploiting the advantages previously expressed involves keeping substantially constant the asymmetry angle B and therefore only varying the deviation angle of said gratting to tune the device to the wavelength. It is then advantageous to include in the spectroscopy device, either before or after the gratting, a mirror whereof the role consists in bringing the direction of the beam coming out of the device in the axis of the incoming beam. This mirror works constantly under a glancing incidence equal to D/2. To increase the reflectivity of this mirror, it is still advantageous to cover its surface with a stack of thin layers formed of the same materials as the first and second stacks of the gratting. The period d′ which should be given to the multilayered stack of the mirror to obtain maximum reflectivity is given by the Bragg relation

$$2 sin ( \frac{D}{2} ) = {r}^{′} ( \frac{λ}{{d}^{′}} ) \qquad ( 12 )$$

where r′ is the order of the Bragg reflection. While comparing with the equations (7), it can be seen that for r′=r the optimum period of the stack of thin layers of the mirror is d′=d cos B. However when the angle B is small, i.e. B<5 degrees, the variation of induced period

$$( \frac{ⅆ - {ⅆ}^{′}}{ⅆ} )$$

is negligible before the width of the reflectivity profile

$$( \frac{Δλ}{λ} ) .$$

Correlatively, the efficiency loss implied by the usage for the mirror of a stack of period d instead of d′ is negligible.

A third embodiment of the invention is represented on FIG. 5. This diffraction gratting comprises a substrate 2 wherein is realised a gratting with triangular profile of period p/2 and of depth d/2=p/2 tan β where β is the slope of the edges of the line 11 of triangular shape. This substrate 2 is then covered with a regular stack of layers of a first 7 and second 8 materials, each having a thickness equal to d/2, in order to form a diffraction gratting comprising a first stack of thin layers 5 and a second stack of thin layers 6, each of period p and d, as described previously. The asymmetry angle B, or still blaze angle characterising the diffraction in the order of indices (q, r) remains defined by

$$B = A tan ( \frac{qd}{rp} ) ,$$

but the preferential blaze direction differs and is that of the order (1,2), B_{1,2}≈2β (FIG. 5).

In practice, it is extremely difficult, let alone impossible, to realise engraven patterns exhibiting abrupt profiles perpendicular to the average surface of the substrate 2. One obtains generally patterns of trapezoidal shape. The structure factor of the unit cell of a diffraction gratting of the invention realised by the deposition of alternate layers on such a substrate 2, is not exactly nil for the even orders of diffraction. However, if the width of the flanks of the trapezoids is sufficiently small relative to the period p, the diffraction gratting thus obtained enables to select the orders of diffraction and to reinforce the diffraction efficiency in these authorised orders.

We shall now describe different examples of new and useful diffraction grattings, according to the invention and which may be manufactured industrially, showing the excellence of the results obtained from these grattings. The spectral domain covered by these grattings extends from the X-rays (example 1) to the infrared via the ultraviolet (examples 2 to 6).

### EXAMPLE 1

FIGS. 6-8 describe a first embodiment of a diffraction gratting of the invention. This diffraction gratting comprises a substrate 2. This substrate 2 is a gratting having an embossed surface formed on a planar surface 3. Said emboss comprises lines 11 parallel to one another having a lamellar profile of depth h=3.8±0.2 nm. The density of lines 11 is 2400 lines/mm, i.e. a period p=417 nm. The ratio hollow/period of this gratting is 0.70±0.01, i.e. the upper portion of the lines 11 has a width I₁, =125±4 nm and the lower portion a width I₂=292±4 nm. The lines 11 have a trapezoidal shape whereof the slope of the edges 13 of the line 11 is comprised between 12 and 15°.

This gratting has been covered with a coating of 20 pairs of alternate is layers of identical thickness of Mo and Si, each layer having substantially a thickness of 3.9 nm, forming a diffraction grafting comprising a thick gratting 9 and a thin surface grafting 10 having an amplitude at the most of d/2. The diffraction gratting thus formed comprises a first periodic stack 5 of thin layers of period d=7.8 nm forming lines 11 parallel to one another, of width I₁=125 nm, separate by 292 nm, spaced periodically with a period p=417 nm and a second periodic stack 6 of thin layers of same period d forming lines 11, parallel to one another, of width I₂=292 nm separate by 125 nm, spaced periodically with a same period p, said second stack 6 being interlaced with the first stack 5 and dephased according to the direction perpendicular to the substrate 2 of the engraving depth h=d/2.

The diffraction grafting thus realised does not reproduce exactly the ideal geometry expected. The cyclic ratio along the direction parallel to the substrate 2 is indeed remote from its desirable value which is close to 0.5. This ratio is here equal to the cyclic ratio I₂/p of the grafting forming the substrate 2 i.e. I²/p=0.70±0.01. Conversely, the agreement of the vertical period with the measured value of the engraving depth h, is excellent.

FIG. 6 gives the result of digital simulations of the efficiency of this gratting of cyclic ratio 0.70 at a wavelength of 1 nm, i.e. 1240 eV, for two types of reflective coatings: a conventional platinum thin layer treatment and the multilayered coating Mo/Si of 3.8 nm thickness per layer, suited to the value of h measured. One has drawn independently the diffraction efficiency in three directions corresponding to the orders of diffraction (−1, 0, +1) of the gratting of period p. The axis of the abscissae 14 represents the incidence angle in degrees and the axis of the ordinates 15 represents the diffraction efficiency. The efficiency of the gratting covered with a platinum layer shows a significant reflectivity in the order 0 (full line curve 16) for the angles smaller than 3 degrees. The efficiencies of the orders −1 (dotted line curve 17) and +1 (dot and dash curve 18) have large variation curves with a maximum at 4% for a glancing incidence of 1.95 degrees and 4.45 degrees, respectively.

The second set of curves corresponds to a gratting as described in the invention covered with alternate layers of Mo and Si of identical thickness equal to 3.8 nm. The order 0 (thin line curve with circles 19) still shows a significant reflectivity for the very glancing incidences, but the cut-off takes place at a smaller angle. There also exists an acute peak of reflectivity at the Bragg angle q=0, r=1 of the multilayer, i.e. 4.27 degrees. The efficiencies of the orders q-=−1 (thin line curve with triangles pointing downwards 20) and q=+1 (full line curve with triangles pointing upwards 21) each shows an acute maximum at 15% on both sides of the peak of order 0 with an angular deviation of 0.92 degrees equal to the asymmetry angle B. It will be noted that on both these curves 20, 21 the persistence of a secondary maximum 22, 23 very attenuated at the positions of the peaks of the surface gratting which correspond to the orders (r=0, q=±1). Finally, one will observe the presence of two relative minima in the order 0, in correspondence with the maxima of the orders q=±1, which confirms the existence of a preferential coupling of the energy towards the blazed orders, i.e. the orders authorised.

FIG. 7 shows the results of measurements obtained for an incident radiation of wavelength 1 nm. The measuring device used is a two-axis goniometer, one carrying the diffraction gratting of the invention and the second the detector. The gratting is illuminated by a parallel brush of light, and to isolate the orders diffracted, one has limited the extent of the detector through a little hole. This FIG. 7 represents the diffraction efficiency of the gratting relative to the glancing incidence angle of the incident radiation. The axis of the abscissae 14 represents the incidence angle in degrees and the axis of the ordinates 15 represents the diffraction efficiency. The first curve 24 (in dotted line) represents the results obtained for the order q=−1, the second curve 25 (in full line), the order q=0 and the third curve 26 (in dots and dashes), the order q=+1. The aspect of the curves of FIG. 6 is not reproduced exactly for several reasons. First of all, the response is widened by the angular response of the measuring system, which is proportional to the convolution of the dimension of the hole by the width of the incident beam. Then, the intensity measured at the apex of the peaks is smaller, 9% instead of 15%, which may come from a slightly trapezoidal profile whereas the simulation assumed a rectangular profile, but their position in glancing incidence angle is exact and coincides with that of the simulation.

FIG. 8 shows three efficiency curves of this same gratting, obtained by maintaining fixed the incidence of the radiation and by varying the angular position of the detector. The angles are marked from the direction of the incident beam, deviation angle D. The axis of the abscissae 14 represents therefore the deviation angle in degrees and the axis of the ordinates 15 represents the diffraction efficiency. The first curve 27 (as a thin dotted line) represents the results obtained for the order −1, the second curve 28 (as a full line), the order 0 and the third curve 29 (in dots and dashes), the order +1. The three curves 27-29 correspond to the values of the incidence for which the efficiency is maximum, in the order −1 to 3.35 degrees, in the order 0 to 4.25 degrees and in the order +1 to 5.2 degrees. The efficiency peaks at 8.55 degrees are not symmetrical but represent a shoulder 30-32 on the side of the great angles. This effect is not associated with the grafting but at the geometry of the incident beam and of the measuring hole, and lies on the calibration measurements made without the gratting. On the measurements made for the third curve 29, i.e. the order +1, at an incidence of 3.35 degrees, there exists a secondary peak 33 to 6.7 degrees which corresponds to the order 0 of the gratting. That peak is very attenuated but is not totally cancelled because the cyclic ratio of the base gratting is 0.7 instead of its desirable value which is 0.5. A small peak of order 0 is also visible at 10.4 degrees on the measurement realised at 5.2 degrees for the third curve, i.e. the order +1. One also notices that the three peaks at 8.55 degrees are not also exactly superimposed as assumed by the theory and the simulation. This may be due to alignment and calibration errors of the measuring goniometer.

### EXAMPLE 2

FIGS. 9-12 describe a second embodiment of a diffraction gratting of the invention for an operation at a wavelength of 193 nm. This diffraction gratting comprises a substrate 2. This substrate 2 is a gratting having an embossed surface formed on a planar surface 3. Said emboss comprises lines 11 parallel to one another having a lamellar profile of depth h 40 nm. The density of lines 11 is 3245.9 lines/mm, i.e. a period p=308 nm. The ratio hollow/period of this grafting is 0.50, i.e. the upper portion of the lines 11 has a width I₁=154 nm and the lower portion a width I₂=154 nm. The lines 11 have a rectangular shape.

This grafting has been covered with a coating of 60 pairs of alternate layers of identical thickness of MgF₂ and LaF₃, each layer having substantially a thickness of 40 nm. The diffraction grafting thus formed comprises two periodic stacks 5 and 6 of thin layers of period d 80 nm forming lines 11 parallel to one another, of width I₁=154 nm, separate by 154 nm, spaced periodically with a period p=308 nm. Both these stacks being interlaced between themselves and dephased according to the direction perpendicular to the substrate 2 of the engraving depth h=d/2.

The diffraction gratting thus realised reproduces exactly the expected ideal geometry for an operation in the Littrow configuration in the order of diffraction q=−3 for a luminous beam of wavelength 193 nm.

The incidence angle of the luminous beam is equal to 70°. “The incidence angle” is defined here as the angle with which the luminous beam falls on the surface of the grafting relative to the normal at this surface. Thus, a luminous beam having a normal incidence at the surface of the gratting has an incidence angle of zero degree.

FIGS. 9 and 10 give respectively the result of digital simulations of the efficiency of this gratting, on a spectral domain ranging from 190 nm to 197 nm for the components of linear polarisation TE (transverse electric) and TM (transverse magnetic). A first curve (curve 36, dotted line) has been obtained for such a gratting not comprising any thin surface grafting 10, as described in a second embodiment of the gratting of the invention on FIG. 3. A second curve (curve 37 as a thick line) has been obtained for such a grafting comprising a thin surface grafting 10, as described in a first embodiment of the gratting of the invention on FIG. 2. This thin surface gratting comprises lines in MgF₂. A third curve (curve 38 as a thin line) has been obtained for such a gratting comprising a thin surface gratting 10 as described in a first embodiment of the gratting of the invention on FIG. 2. This thin surface gratting comprises lines in LaF₃.

The axis of the abscissae 34 represents the wavelengths in Angstroms and the axis of the ordinates 35 represents the diffraction efficiency corresponding to the order of diffraction −3 of the gratting of period p. The first curve 36 shows a very significant reflectivity (greater than 90%) in the vicinity of 193 nm for both polarisations TE and TM. The efficiencies obtained for the second curve 37 are slightly smaller. The polarisation efficiencies TM represent a spectral width of 3.5 nm, greater than that obtained in polarisation TE.

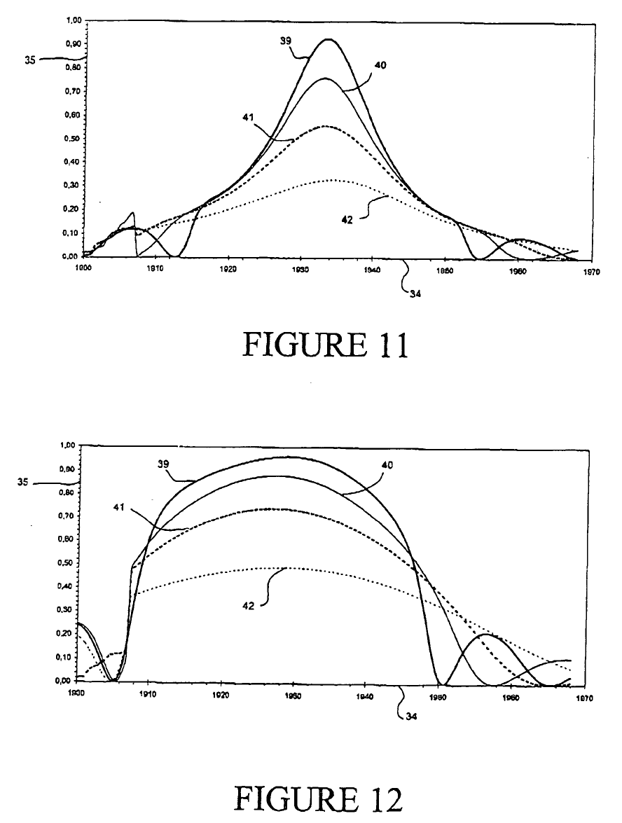

FIGS. 11 and 12 show the result of digital simulations of the efficiency of this grafting on a spectral domain ranging from 190 nm to 197 nm in the is order −3 of diffraction of the gratting respectively for the components of linear polarisation TE (transverse electric) and TM (transverse magnetic). Four curves 3942 show respectively the diffraction efficiency of the grafting relative to the wavelength of the incident beam for numbers of pairs of different alternate layers 60 (curve 39 as a thick full line), 40 (curve 40 as a thin full line), 30 (curve 41 as a thick dotted line) and 20 (curve 42 as a thin dotted line). The axis of the abscissae 34 represents the wavelengths en Angstrom and the axis of the ordinates 35 represents the diffraction efficiency.

The diffraction efficiency of the gratting is the higher so that the number of periods of the stack of the multilayered coating is high regardless of the polarisation of the incident wave. A minimum of 30 pairs of layers is necessary to exceed 50% efficiency, and it is considered that above 60 pairs of layers, the maximum efficiency is reached for this embodiment.

### EXAMPLE 3

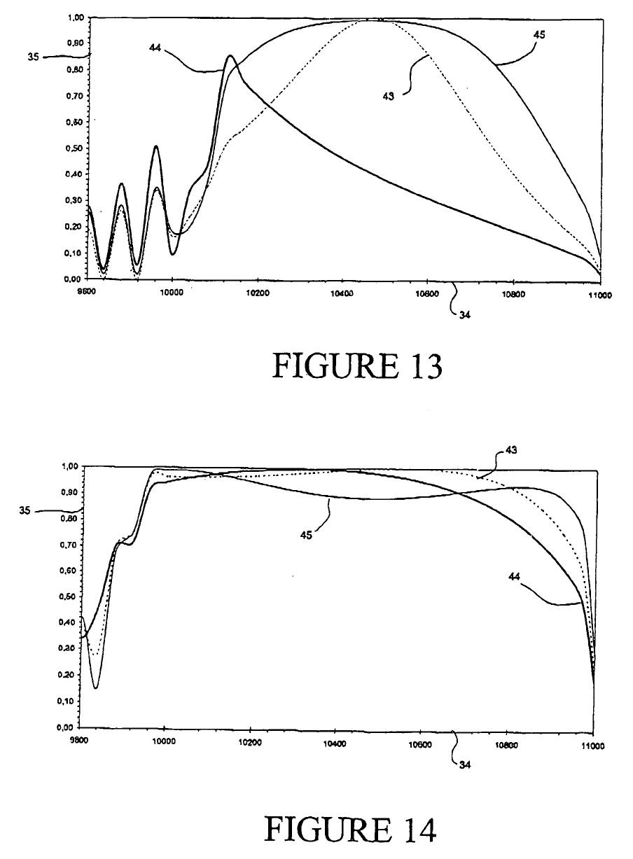

FIGS. 13-15 describe a third embodiment of a diffraction gratting of the invention for an operation at a wavelength of 1054 nm. This diffraction gratting comprises a substrate 2. This substrate 2 is a gratting having an embossed surface formed on a planar surface 3. Said emboss comprises lines 11 parallel to one another having a lamellar profile of depth h=195 nm. The density of lines 11 is 1740 lines/mm, i.e. period p=575 nm. The ratio hollow/period of this grafting s 0.50, i.e. the upper portion of the lines 11 has a width I₁=287.5 nm and the lower portion a width I₂=287.5 nm. The lines 11 have a rectangular shape.

This grafting has been covered with a coating of 60 pairs of alternate layers of identical thickness of HfO₂ and SiO₂, each layer having substantially a thickness of 195 nm. The diffraction gratting thus formed comprises two periodic stacks 5 and 6 of thin layers of period d=390 nm forming lines 11 parallel to one another, of width I₁=287.5 nm, separate by 287.5 nm, spaced periodically with a period p=575 nm. Both these stacks being interlaced between themselves and dephased according to the direction perpendicular to the substrate 2 of the engraving depth h=d/2.

The diffraction gratting thus realised reproduces exactly the expected ideal geometry for a configuration close to the Littrow configuration in the order of diffraction q=−1 for a luminous beam of wavelength 1054 nm. The incidence angle of the luminous beam is equal to 66° (relative to the normal to the grafting).

FIGS. 13 and 14 show the result of digital simulations of the efficiency of this grafting, on a spectral domain ranging from 980 nm to 1100 nm in polarisation TE (FIG. 13) and in polarisation TM (FIG. 14). A first curve (curve 43 as a dotted line) has been obtained for such a gratting not comprising any thin surface gratting 10, as described in a second embodiment of the grafting of the invention on FIG. 3. A second curve (curve 44 as a thick full line) has been obtained for such a grafting comprising a thin surface grafting 10, as described in a first embodiment of the gratting of the invention on FIG. 2. This thin surface grafting 10 comprises lines in HfO₂. A third curve (curve 45 as a thin full line) has been obtained for such a grafting comprising a thin surface gratting 10, as described in a first embodiment of the gratting of the invention on FIG. 2. This thin surface grating comprises lines in SiO₂.

The axis of the abscissae 34 represents the wavelengths in Angstroms and the axis of the ordinates 35 represents the diffraction efficiency corresponding to the order of diffraction −1 of the grafting of period p.

The first curve 43 shows very significant diffraction efficiencies (greater than 95%) for the linear component in polarisation TM, in the vicinity of 1054 nm and on a wide spectral band (from 1010 nm to 1070 nm). The efficiencies in polarisation TM for the three curves 40-42 are greater than 88% on a wide spectral domain around the wavelength. 1054 nm. The efficiency profiles in polarisation TM represent a spectral width greater than that obtained in polarisation TE. The third curve 45 shows in polarisation TE a spectral width greater than that of the first curve 43.

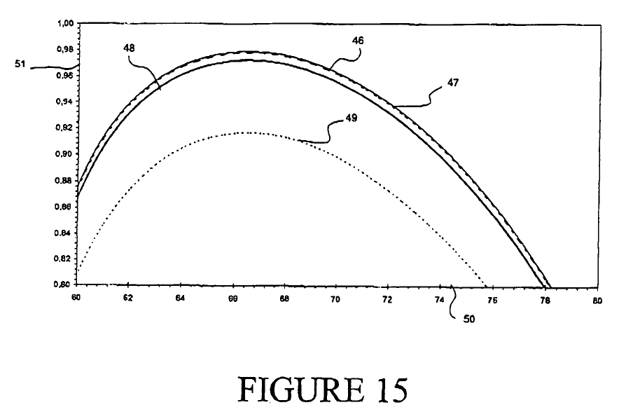

FIG. 15 gives the result of digital simulations of the diffraction efficiency in polarisation TE of the gratting not comprising any thin surface gratting 10 for an incidence angle varying between 60° and 80°, and for a number of pairs of variable alternate layers: 60 (curve 46 as a thin full line), 20 (curve 47 as a thick dotted line), 15 (curve 48 as a thick full line) and 10 (curve 49 as a thin dotted line). The axis of the abscissae 50 represents the incidence angle of the incident beam of wavelength 1054 nm and the axis of the ordinates 51 represents the diffraction efficiency for the order of diffraction −1.

The diffraction efficiency of the gratting is the higher so that the number of periods of the stack of the thick gratting 9 is high. A minimum of 20 pairs of layers is necessary to reach the maximum efficiency permitted by this embodiment (98%), and 15 pairs of layers suffice to come close to 99% of this maximum (97%). The efficiency of the gratting is maximum for an operation in Littrow configuration.

### EXAMPLE 4

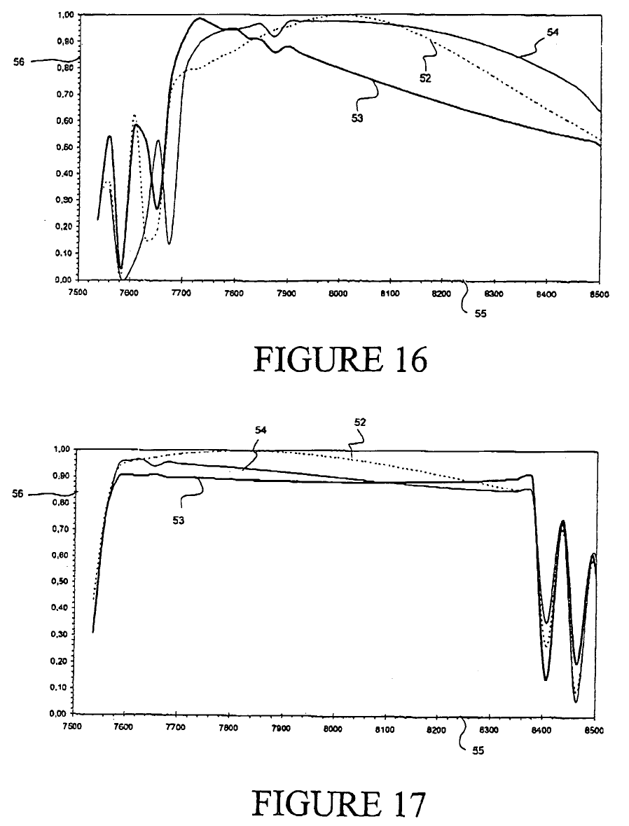

FIGS. 16-17 describe a fourth embodiment of the diffraction gratting of the invention for an operation at a wavelength of 800 nm. This diffraction gratting comprises a substrate 2. This substrate 2 is a gratting having an embossed surface formed on a planar surface 3. Said emboss comprises lines 11 parallel to one another having a lamellar profile of depth h=129.25 nm. The density of lines 11 is of 1480 lines/mm, i.e. a period p=676 nm. The ratio hollow/period of this gratting is 0.50, i.e. the upper portion of the lines 11 has a width I₁=338 nm and the lower portion a width I₂=338 nm. The lines 11 have a rectangular shape.

This gratting has been covered with a coating of 60 pairs of alternate layers of identical thickness of HfO₂ and SiO₂, each layer having substantially a thickness of 129.25 nm. The diffraction gratting thus formed comprises two periodical stacks 5 and 6 thin layers of period d=258.5 nm forming lines 11 parallel to one another, of width I₁=338 nm, separate by 338 nm, spaced periodically with a period p=676 nm. Both these stacks being interlaced between themselves and dephased according to the direction perpendicular to the substrate 2 of the engraving depth h=d/2.

The diffraction gratting thus realised reproduces exactly the expected ideal geometry for an operation in a configuration close to the Littrow configuration in the order of diffraction q=−1 for a luminous beam of wavelength 800 nm.

The incidence angle of the luminous beam on this gratting is equal to 41.5° (relative to the normal to the gratting).

FIGS. 16 and 17 show the results of digital simulations of the efficiency of this gratting, one a spectral domain ranging from 750 nm to 850 nm in polarisation TE (FIG. 16) and in polarisation TM (FIG. 17). A first curve (curve 52 as a doffed line) has been obtained for such a gratting not comprising any thin surface gratting 10, as described in a second embodiment of the gratting of the invention on FIG. 3. A second curve (curve 53 as a thick full line) has been obtained for such a gratting comprising a thin surface gratting 10, as described in a first embodiment of the gratting of the invention on FIG. 2. This thin surface gratting comprises lines in HfO₂. A third curve (curve 54 as a thin full line) has been obtained for such a gratting comprising a thin surface gratting 10, as described in a first embodiment of the gratting of the invention on FIG. 2. This thin surface gratting 10 comprises lines in SiO₂.

The axis of the abscissae 55 represents the wavelengths in Angstroms and the axis of the ordinates 56 represents the diffraction efficiency corresponding to the order of diffraction −1 of the gratting of period p.

The efficiencies of the gratting corresponding to the first curve 52 show very high values (greater than 95%) in the vicinity of 800 nm for both polarisations TE and TM on a wide spectral band. The efficiencies in polarisation TM for the three curves 52-54 are greater than 88% on a wide spectral domain around the wavelength 1054 nm. The efficiency curves in polarisation TM show a spectral width greater than that obtained in polarisation TE. The third curve 54 shows in polarisation TE a spectral width greater than that of the first curve 52.

The behaviour of this fourth embodiment is very similar to that of the example 3.

### EXAMPLE 5

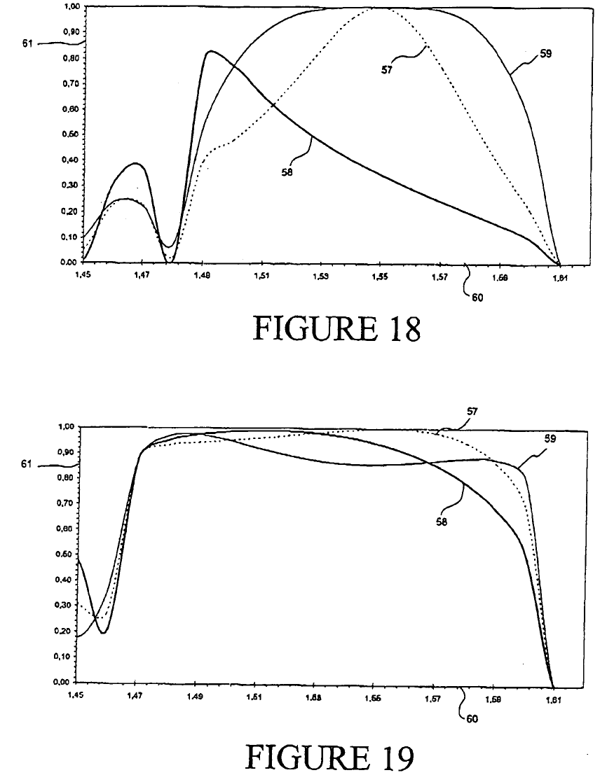

FIGS. 18-21 describe a fifth embodiment of a diffraction gratting of the invention for an operation at a wavelength of 1550 nm. This diffraction gratting comprises a substrate 2. This substrate 2 is a gratting having an embossed surface formed on a planar surface 3. Said emboss comprises lines 11 parallel to one another having a lamellar profile of depth h=286.35 nm. The density of lines 11 is of 1200 lines/mm, i.e. a period p=833 nm. The ratio hollow/period of this gratting is 0.50, i.e. the upper portion of the lines 11 has a width I₁=416.6 nm and the lower portion a width I₂=416.6 nm. The lines 11 have a rectangular shape.

This gratting has been covered with a coating of 20 pairs of alternate layers of identical thickness of HfO₂ and SiO₂, each layer having substantially a thickness of 286.35 nm. The diffraction gratting thus formed comprises two periodic stacks 5 and 6 thin layers of period d=572.7 nm forming lines 11 parallel to one another, of width I₁=416.6 nm, separate by 416.6 nm, spaced periodically with a period p=833 nm. Both these stacks being interlaced between themselves and dephased according to the direction perpendicular to the substrate 2 of the engraving depth h=d/2.

The diffraction gratting thus realised reproduces exactly the expected ideal geometry for an operation in a configuration close to the Littrow configuration in the order of diffraction q=−1 for a luminous beam of wavelength 1550 nm.

The incidence angle of the luminous beam on this gratting is equal to 68.44° (relative to the normal to the gratting).

FIGS. 18 and 19 give the results of digital simulations of the efficiency of this grafting, on a spectral domain ranging from 1450 nm to 1620 nm in polarisation TE (FIG. 18) and in polarisation TM (FIG. 19). A first curve (curve 57 as a dotted line) has been obtained for such a grating not comprising a thin surface gratting 10, as described in a second embodiment of the gratting of the invention on FIG. 3. A second curve (curve 58 as a thick full line) has been obtained for such a gratting exhibiting a thin surface grafting 10, as described in a first embodiment of the gratting of the invention on FIG. 2. This thin surface gratting 10 comprises lines in HfO₂. A third curve (curve 59 as a thin full line) has been obtained for such a grafting exhibiting a thin surface gratting 10, as described in a first embodiment of the gratting of the invention on FIG. 2. This thin surface grafting 10 comprises lines in SiO₂.

The axis of the abscissae 60 represents the wavelengths in microns and the axis of the ordinates 61 represents the diffraction efficiency corresponding to the order of diffraction −1 of the gratting of period p.

The efficiencies of the gratting corresponding to the first curve 57 shows very high values (greater than 90%) in the vicinity of 1550 nm for the polarisation TM on a wide spectral band (from 1470 nm to 1580 nm). The efficiencies in polarisation TM of the three curves 57-59 are greater than 85% on a wide spectral domain around the wavelength 1550 nm. The efficiency curves in polarisation TM show a spectral width greater than that obtained in polarisation TE. The third curve 59 in polarisation TE shows a spectral width greater than that of the first curve 57.

The particular embodiment of the gratting leading to the third curve is enables to contemplate an operation with low polarisation ratio and high efficiency on a wide spectral domain.

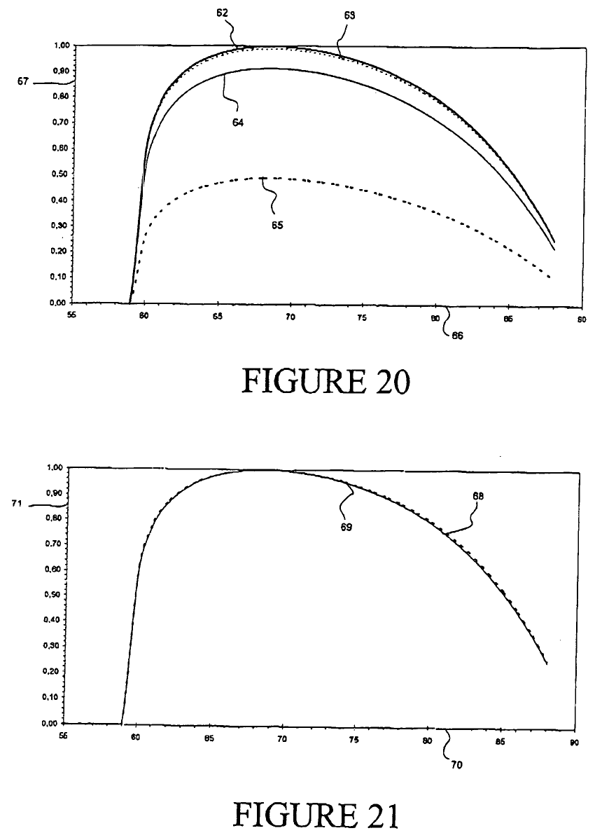

FIG. 20 give the results of digital simulations of the efficiency of the gratting not comprising any thin surface gratting 10 for an incidence angle varying between 55° and 88°, and for a number of pairs of variable alternate layers: 20 (curve 62 as a thick full line), 15 (curve 63 as a thin dotted line), 10 (curve 64 as a thin full line) and 5 (curve 65 as a thick dotted line). The axis of the abscissae 66 represents the incidence angle (defined to be equal to 0° when the incidence is normal to the gratting) and the axis of the ordinates 67 represents the diffraction efficiency.

The efficiency of the gratting is the higher so that the number of periods of the stack of the multilayered coating is high. A minimum of 15 to 20 pairs of layers is necessary to reach the maximum efficiency permitted by this embodiment (99%).

FIG. 21 enables to compare the results of digital simulations of the efficiency of the grafting of FIG. 20 for the same range of incidence angle for the linear polarisations TE (curve 68 as a full line) and TM (curve 69 as a dotted line) at the wavelength of 1550 nm. The axis of the abscissae 70 represents the incidence angle (defined to be equal to 0° when the incidence is normal to the gratting) and the axis of the ordinates 71 represents the diffraction efficiency. This embodiment enables to contemplate an operation at low polarisation ratio with any incidence angle. The efficiency remains optimum for an operation in Littrow configuration.

### EXAMPLE 6

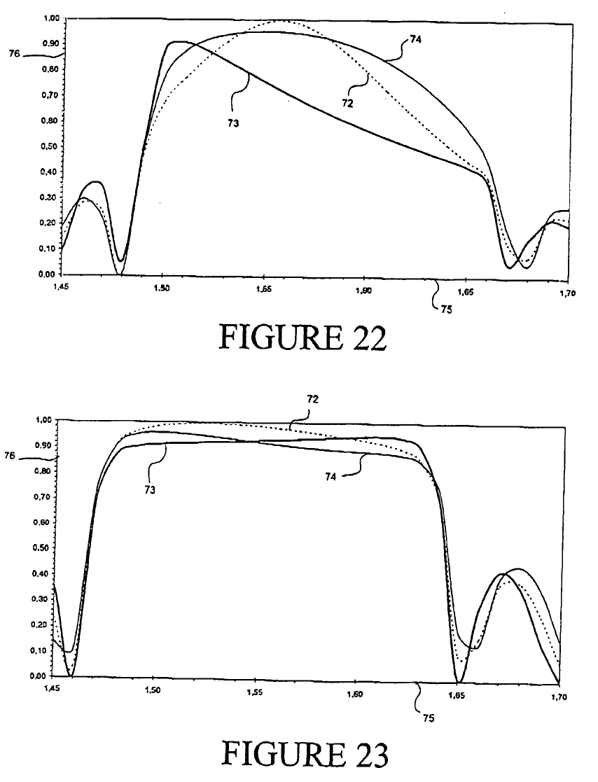

Les FIGS. 22-24 describe a sixth embodiment of a diffraction gratting of the invention for an operation at a wavelength of 1550 nm. This diffraction gratting comprises a substrate 2. This substrate 2 is a gratting having an embossed surface formed on a planar surface 3. Said emboss comprises lines 11 parallel to one another having a lamellar profile of depth h=260.7 nm. The density of lines 11 is of 900 lines/mm, i.e. a period p=1111 nm. The ratio hollow/period of this gratting is 0.50, i.e. the upper portion of the lines 11 has a width I₁=555.5 nm and the lower portion a width I₂=555.5 nm. The lines 11 have a rectangular shape.

This gratting has been covered with a coating of 20 pairs of alternate layers of identical thickness of HfO₂ and SiO₂, each layer having substantially a thickness of 260.7 nm. The diffraction gratting thus formed comprises two periodic stacks 5 and 6 of thin layers of period d=521.4 nm forming lines 11 parallel to one another, of width I₁=555.5 nm, separate by 555.5 nm, spaced periodically with a period p=1111 nm. Both these stacks being interlaced between themselves and dephased according to the direction perpendicular to the substrate 2 of the engraving depth h=d/2.

The diffraction gratting thus realised reproduces exactly the expected ideal geometry for an operation in a configuration close to the Littrow configuration in the order of diffraction q=−1 for a luminous beam of wavelength 1550 nm.

The incidence angle of the luminous beam on this gratting is equal to 44.23° (relative to the normal to the gratting).

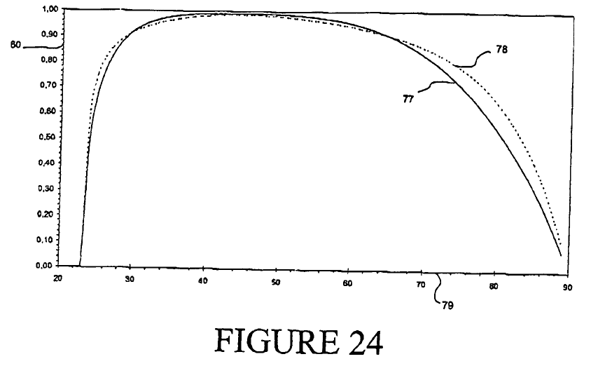

FIGS. 22 and 23 give the results of digital simulations of the efficiency of this gratting, on a spectral domain ranging from 1450 nm to 1700 nm in polarisation TE (FIG. 22) and in polarisation TM (FIG. 23). A first curve (curve 72 as a dotted line) has been obtained for such a gratting not comprising any thin surface gratting 10, as described in a second embodiment of the gratting of the invention on FIG. 3. A second curve (curve 73 as a thick full line) has been obtained for such a gratting exhibiting a thin surface gratting 10, as described in a first embodiment of the gratting of the invention on FIG. 2. This thin surface gratting 10 comprises lines in HfO₂. A third curve (curve 74 as a thin full line) has been obtained for such a gratting exhibiting a thin surface gratting 10, as described in a first embodiment of the gratting of the invention on FIG. 2. This thin surface gratting 10 comprises lines in SiO₂.

The axis of the abscissae 75 represents the wavelengths in microns and the axis of the ordinates 76 represents the diffraction efficiency corresponding to the order of diffraction −1 of the gratting of period p.

The efficiencies of the gratting corresponding to the first curve 72 shows very high values (greater than 90%) in the vicinity of 1550 nm for the polarisation TM on a wide spectral band (from 1480 nm to 1620 nm). The efficiencies in polarisation TM of the gratting for the three curves 72-74 are greater than 85% on a wide spectral domain around the wavelength 1550 nm. The efficiencies in polarisation TM show a spectral width greater than that obtained in polarisation TE. The third curve 74 shows in polarisation TE a spectral width greater than that of the first curve 72.

The particular embodiment of the gratting leading to the third curve 74 enables to contemplate an operation with low polarisation ratio and high efficiency on a wide spectral domain, this domain being even more widespread than that of the example 5.

FIG. 24 enables to compare the results of digital simulations of the efficiency of the gratting not comprising any thin surface gratting 10 for an incidence angle varying between 20° and 88°, for the linear polarisations TE (curve 77 as a full line) and TM (curve 78 as a dotted line) at the wavelength of 1550 nm. The axis of the abscissae 79 represents the incidence angle (defined to be equal to 0° when the incidence is normal to the grafting) and the axis of the ordinates 80 represents the diffraction efficiency. This embodiment enables to contemplate an operation at low polarisation ratio with any incidence angle. The efficiency remains optimum for an operation in the Littrow configuration.

The examples confirm that the invention finds applications in a wide spectral domain of the X-rays at the infrared.

1. A two-dimensional diffraction gratting for the dispersion of polychromatic or quasi-monochromatic luminous flux including
a substrate (2) having a surface (3),
a first (5) and a second (6) stacks of thin biperiodic layers of period d in the thickness direction, including at least ten periods, each period d being formed of layers of at least two different materials (7, 8), said stacks (5, 6) forming contiguous lines (11) of width p/2, parallel to one another, and repeated periodically along a direction parallel to the surface of the substrate (2) with a period p, the second stack (6) being alternate with the first stack (5) and offset in width by d/2, so that the stacks (5 and 6) form a thick gratting (9) carried by the substrate (2), characterized in that thick gratting (9) consists of the doubly periodical repetition of a same unit cell, topped with a thin surface gratting (10) having an amplitude at the most equal to d/2.

2. A two-dimensional diffraction gratting according to claim 1, characterised in that the external surface of the two-dimensional gratting does not include any thin surface gratting (10).

3. A two-dimensional diffraction gratting according to claim 1, characterised in that the substrate (2) whereon lies the thick gratting (9) possesses an embossed surface including lines (11) parallel to one another, of periodicity p and being in phase with one of the stacks.

4. A two-dimensional diffraction gratting according to claim 1 characterised in that the substrate (2) has an embossed surface exhibiting a triangular profile of a base width p/2, of a depth d/2 at the most and of periodicity p/2 in phase with the stacks.

5. A two-dimensional diffraction gratting according to claim 1, characterised in that the substrate (2) has an upper planar surface (3).

6. A two-dimensional diffraction grafting according to claim 1, characterised in that the substrate (2) has a concave, convex, spherical or aspherical upper surface (3).

7. A two-dimensional diffraction grafting according to claim 1 characterised in that the period p of the lines (11) of the grafting varies continuously according to the position at the surface (3) of the substrate (2).

8. A two-dimensional diffraction grafting according to claim 1, characterised in that the period d of the thin layers varies continuously according to the position at the surface (3) of the substrate (2).

9. A two-dimensional diffraction grafting according to claim 1, characterised in that it comprises a protection layer deposited on said first and second stacks (5, 6) of layers.

10. A two-dimensional diffraction grafting according to claim 1, characterised in that it comprises a hooking layer between the substrate (2) and the first layer of each stack (5, 6).

11. A two-dimensional diffraction gratting according to claim 1, characterised in that it comprises a barrier layer between successive materials (7, 8).

12. A two-dimensional diffraction gratting according to claim 1, characterised in that the distribution of the indices of the materials (7, 8) forming an unit cell shows symmetries or antisymmetries so that, when in use, at least one order of diffraction is weakened or strengthened.

13. A two-dimensional diffraction grafting according to claim 12, characterised in that the distribution of the indices of the materials (7, 8) forming the unit cell shows a symmetry relative to the centre of said unit cell.

14. A two-dimensional diffraction gratting according to claim 12, characterised in that the unit cell is formed of two materials (7, 8) having different optical indices.

15. A two-dimensional diffraction gratting according to claim 1, characterised in that the period p of the grafting and the period d of the stacks (5, 6) vary continuously according to the position at the surface (12) of the gratting so that the ratio d/p remains constant at all points.

16. A process for the preparation of a two-dimensional diffraction gratting according to claim 1, characterised in that
an embossed surface including periodical embossed or hollow patterns, of height or depth d/2 is performed on a substrate (2),
a stack of thin periodical layers of period d is deposited, each period d consisting of layers of at least two different materials (7, 8), so that a first and a second stacks (5, 6) are formed, having the same configuration, alternate, contiguous and dephased by d/2 along the direction of periodicity d perpendicular to the surface (3) of the substrate (2).

17. A process for the preparation of a two-dimensional diffraction grafting according to claim 16, characterised in that periodical hollow patterns are formed by an in situ engraving process.

18. A process for the preparation of a two-dimensional diffraction gratting according to claim 16, characterised in that periodical embossed patterns are formed by an in situ deposition process.

19. A process for the preparation of a two-dimensional diffraction grafting according to claim 16, characterised in that it contains a means to smoothen the embossed surface.

20. A spectroscopic device for analysing or filtering a luminous source including at least one two-dimensional diffraction gratting characterised in that said gratting is a diffraction gratting according to claim 1.

21. A spectroscopic device according to claim 19, intended to receive a luminous beam including at least one radiation centered on a wavelength λ₀ emitted by a luminous source, the diffracted radiation of wavelength λ₀ by said gratting forming a deviation angle D with the incident beam, characterised in that
the two-dimensional diffraction gratting is oriented so that the normal to the gratting forms an angle B constant with ±10% with the bisectrix at the deviation angle D,
the angle D and the wavelength λ₀ of said radiation verifying the following equation:
$$2 sin ( \frac{D}{2} ) \times sin B = q \frac{{λ}_{0}}{p}$$
where p is the period of the gratting in the plane of its surface, q is the order of diffraction along this direction.

22. A spectroscopic device according to claim 21, characterised in that the angle B is defined by the relation
$$tan B = \frac{qd}{rp} ( 1 - \frac{( 1 - \overline{n} )}{{( \frac{r {λ}_{0}}{2 d} )}^{2} - {( \frac{qd}{rp} )}^{2}} )$$
where d is the period of the gratting according to the axis perpendicular to the surface of the gratting and r the order of diffraction along this direction and \overline{n} the average index of the gratting.

23. A spectroscopic device according to claim 20, characterised in that it contains a dispersive device including said two-dimensional diffraction gratting and a mirror place before or after said gratting,
said mirror including a mulitlayered structure comprising the same materials and having the same periodicity along a direction normal to the surface as said first and second stacks (5, 6) of layers of the diffraction gratting,
said mirror being oriented in order to receive the luminous beam diffracted under an incidence angle D/2 relative to its surface so that the beam diffracted by the gratting and transmitted by the whole device remains parallel to the incident beam.
